(19) United States
(12) Patent Application Publication
(10) Pub. No.: US 2024/0378047 A1
(43) Pub. Date: Nov. 14, 2024

(54) SYSTEM AND METHOD FOR UPDATING GPTS (GLOBAL PARTITIONING TABLES) AND PARTITION CONTENTS OF A COMPUTING DEVICE IN REAL-TIME SYSTEM RECOVERY MODE

(71) Applicant: NIO Technology (Anhui) Co., Ltd., Hefei (CN)

(72) Inventors: Emmanuel L. Saez, Saratoga, CA (US); Genisim Tsilker, San Jose, CA (US)

(73) Assignee: NIO Technology (Anhui) Co., Ltd., Hefei (CN)

(21) Appl. No.: 18/659,635

(22) Filed: May 9, 2024

Related U.S. Application Data
(60) Provisional application No. 63/501,189, filed on May 10, 2023.

(51) Int. Cl. G06F 8/65

(52) U.S. Cl. CPC G06F 8/65

(57) ABSTRACT

Embodiments of the present disclosure are directed to performing an over-the-air firmware update that includes re-partitioning of memory of a device by using a recovery mode of the device. According to one embodiment, a method for performing an over-the-air firmware update on a mobile device can comprise receiving, via a wireless communications interface, a firmware update package. In response to receiving the firmware update package, the mobile device can be switched from a normal mode of operation for the mobile device to a recovery mode of operation for the mobile device. While in the recovery mode of operation for the mobile device, the received firmware update package can be installed. Installing the received firmware update package can also update global partition tables of a memory of the mobile device.

### CROSS REFERENCE TO RELATED APPLICATION

The present application claims the benefits of and priority, under 35 U.S.C. § 119 (e), to U.S. Provisional Application No. 63/501,189 filed May 10, 2023 by Saez, et. al. and entitled “System and Method for Updating GPTS (Global Partitioning Tables) and Partition Contents of a Computing Device in Real-Time System Recovery Mode” of which the entire disclosure is incorporated herein by reference for all purposes.

### FIELD OF THE DISCLOSURE

The present disclosure is generally directed to software updates and, in particular, to performing an over-the-air firmware update that includes re-partitioning of memory of a device.

### BACKGROUND

In computing systems, firmware is a specific class of computer software that provides the low-level control for a device's specific hardware. Firmware, such as the Basic Input/Output Systems (BIOS) of a personal computer, may contain basic functions of a device. For less complex devices, firmware may act as the device's complete operating system.

Firmware is stored in non-volatile, Read Only Memory (ROM) such as flash memory, for example. As such, updating firmware typically requires the memory to be physically replaced or reprogrammed through a special procedure. Common reasons for updating firmware include fixing bugs or adding features. However, the procedures for performing such updates typically cannot be performed by an end user of the device and require the device to be taken or sent for service. Hence, there is a need in the art for improved methods and systems for performing a firmware update on a computing device.

### BRIEF SUMMARY

Embodiments of the present disclosure are directed to performing an over-the-air firmware update that includes re-partitioning of memory of a device by using a recovery mode of the device. According to one embodiment, a method for performing an over-the-air firmware update on a mobile device can comprise receiving, via a wireless communications interface, a firmware update package. In response to receiving the firmware update package, the mobile device can be switched from a normal mode of operation for the mobile device to a recovery mode of operation for the mobile device. While in the recovery mode of operation for the mobile device, the received firmware update package can be installed. Installing the received firmware update package can also update global partition tables of a memory of the mobile device.

According to one embodiment, a method for performing an over-the-air firmware update on a mobile device can comprise: receiving, by a processor of the mobile device, via a wireless communications interface, a firmware update package; in response to receiving the firmware update package, switching, by the processor of the mobile device, from a normal mode of operation for the mobile device to a recovery mode of operation for the mobile device; and while in the recovery mode of operation for the mobile device, installing, by the processor of the mobile device, the received firmware update package, wherein installing the received firmware update package updates global partition tables of a memory of the mobile device.

In one aspect, installing the received firmware update package can comprise: synchronizing one or more primary global partition tables of the memory of the mobile device with one or more secondary partition tables of the memory of the mobile device; reading one or more global partitioning tables for one or more logical unit numbers of the memory of the mobile device from the received firmware update package; saving the one or more global partition tables for the one or more logical unit numbers of the memory of the mobile device; flashing the one or more global partitioning table for the one or more logical unit numbers of the memory of the mobile device read from the received firmware update package to the memory of the mobile device; parsing a partition list of the firmware update package; determining, based on the parsed partition list, whether partitions of the memory of the mobile device remain to be updated; and in response to determining no partitions of the memory of the mobile device remain to be update, switching from the recovery mode of operation of the mobile device to the normal mode of operation of the mobile device.

In one aspect, the method can further comprise: in response to determining partitions of the memory of the mobile device remain to be updated, reading a partition image from the received firmware update package; saving a corresponding partition image from the memory of the mobile device; flashing the partition image read from the firmware update package to the memory of the mobile device; removing the read partition image from the parsed partition list; determining, based on the parsed partition list, whether partitions of the memory of the mobile device remain to be updated; and in response to determining no partitions of the memory of the mobile device remain to be update, switching from the recovery mode of operation of the mobile device to the normal mode of operation of the mobile device.

In one aspect, the method can further comprise in response to in response to determining partitions of the memory of the mobile device remain to be updated repeating the reading a partition image from the received firmware update package, saving a corresponding partition image from the memory of the mobile device, flashing the partition image read from the firmware update package to the memory of the mobile device, removing the read partition image from the parsed partition list, and determining, based on the parsed partition list, whether partitions of the memory of the mobile device remain to be updated until no partitions of the memory of the mobile device remain to be update; and switching from the recovery mode of operation of the mobile device to the normal mode of operation of the mobile device.

In one aspect, the method can further comprise determining whether updating the global partition tables of the memory of the mobile device was successful.

In one aspect, the method can further comprise in response to determining updating the global partition tables of the memory of the mobile device was not successful: restoring the one or more secondary global partitioning tables of the memory of the mobile device as the one or more primary global partitioning tables of the memory of the mobile device; restoring saved partition images to the memory of the mobile device; and switching from the recovery mode of operation of the mobile device to the normal mode of operation of the mobile device.

In one aspect, the mobile device can comprise an electronic controller module.

In one aspect, the electronic control module can comprise an electronic control module of a vehicle.

According to another embodiment, an electronic control module can comprise: a wireless communications interface; a processor coupled with the wireless communications interface; and a memory coupled with and readable by the processor and storing therein a set of instructions which, when executed by the processor, can cause the processor to perform an over-the-air firmware update by: receiving, via the wireless communications interface, a firmware update package; in response to receiving the firmware update package, switching from a normal mode of operation for the electronic control module to a recovery mode of operation for the electronic control module; and while in the recovery mode of operation for the electronic control module, installing the received firmware update package, wherein installing the received firmware update package updates global partition tables of the memory of the electronic control module.

In one aspect, installing the received firmware update package can comprise: synchronizing one or more primary global partition tables of the memory with one or more secondary partition tables of the memory; reading one or more global partitioning tables for one or more logical unit numbers of the memory from the received firmware update package; saving the one or more global partition tables for the one or more logical unit numbers of the memory; flashing the one or more global partitioning table for the one or more logical unit numbers of the memory read from the received firmware update package to the memory; parsing a partition list of the firmware update package; determining, based on the parsed partition list, whether partitions of the memory remain to be updated; and in response to determining no partitions of the memory remain to be update, switching from the recovery mode of operation to the normal mode of operation.

In one aspect, in response to determining partitions of the memory remain to be updated, the instructions can further cause the processor to: read a partition image from the received firmware update package; save a corresponding partition image from the memory; flash the partition image read from the firmware update package to the memory; remove the read partition image from the parsed partition list; determine, based on the parsed partition list, whether partitions of the memory remain to be updated; and in response to determining no partitions of the memory remain to be update, switch from the recovery mode of operation to the normal mode of operation.

In one aspect, the instructions can further cause the processor to: in response to in response to determining partitions of the memory remain to be updated repeating the reading a partition image from the received firmware update package, save a corresponding partition image from the memory, flash the partition image read from the firmware update package to the memory, remove the read partition image from the parsed partition list, and determine, based on the parsed partition list, whether partitions of the memory remain to be updated until no partitions of the memory remain to be update; and switch from the recovery mode of operation to the normal mode of operation.

In one aspect, the instructions can further cause the processor to determine whether updating the global partition tables of the memory was successful.

In one aspect, in response to determining updating the global partition tables of the memory was not successful, the instructions can further cause the processor to: restore the one or more secondary global partitioning tables of the memory as the one or more primary global partitioning tables of the memory; restore saved partition images to the memory; and switch from the recovery mode of operation to the normal mode of operation.

According to yet another embodiment, a vehicle can comprise a wireless communications interface; an electronic control module coupled with the wireless communications interface, the electronic control module comprising: a processor; and a memory coupled with and readable by the processor and storing therein a set of instructions which, when executed by the processor, can cause the processor to perform an over-the-air firmware update on a mobile device by: receiving, via the wireless communications interface, a firmware update package; in response to receiving the firmware update package, switching from a normal mode of operation for the electronic control module to a recovery mode of operation for the electronic control module; and while in the recovery mode of operation for the electronic control module, installing the received firmware update package, wherein installing the received firmware update package updates global partition tables of the memory of the electronic control module.

In one aspect, installing the received firmware update package can comprise synchronizing one or more primary global partition tables of the memory of the mobile device with one or more secondary partition tables of the memory; reading one or more global partitioning tables for one or more logical unit numbers of the memory from the received firmware update package; saving the one or more global partition tables for the one or more logical unit numbers of the memory; flashing the one or more global partitioning table for the one or more logical unit numbers of the memory read from the received firmware update package to the memory; parsing a partition list of the firmware update package; determining, based on the parsed partition list, whether partitions of the memory remain to be updated; and in response to determining no partitions of the memory remain to be update, switching from the recovery mode of operation to the normal mode of operation.

In one aspect, in response to determining partitions of the memory remain to be updated, the instructions can further cause the processor to: read a partition image from the received firmware update package; save a corresponding partition image from the memory; flash the partition image read from the firmware update package to the memory; remove the read partition image from the parsed partition list; determine, based on the parsed partition list, whether partitions of the memory remain to be updated; and in response to determining no partitions of the memory remain to be update, switch from the recovery mode of operation to the normal mode of operation.

In one aspect, the instructions can further cause the processor to: in response to in response to determining partitions of the memory remain to be updated repeating the reading a partition image from the received firmware update package, save a corresponding partition image from the memory, flash the partition image read from the firmware update package to the memory, remove the read partition image from the parsed partition list, and determine, based on the parsed partition list, whether partitions of the memory remain to be updated until no partitions of the memory remain to be update; and switch from the recovery mode of operation to the normal mode of operation.

In one aspect, the instructions can further cause the processor to determine whether updating the global partition tables of the memory was successful.

In one aspect, in response to determining updating the global partition tables of the memory was not successful, the instructions can further cause the processor to: restore the one or more secondary global partitioning tables of the memory as the one or more primary global partitioning tables of the memory; restore saved partition images to the memory; and switch from the recovery mode of operation to the normal mode of operation.

### BRIEF DESCRIPTION OF THE DRAWINGS

FIG. 1 is a diagram illustrating an exemplary system in which over-the-air firmware updates can be performed according to various embodiments of the present disclosure.

FIG. 2 is a block diagram illustrating additional details of an exemplary firmware update service according to one embodiment of the present disclosure.

FIG. 3 is a block diagram illustrating additional details of an exemplary mobile device or electronic control module according to one embodiment of the present disclosure.

FIG. 4 is a flowchart illustrating an exemplary process for creating and distributing an over-the-air firmware update according to one embodiment of the present disclosure.

FIG. 5 is a flowchart illustrating additional details of an exemplary process for creating a global partition table in a binary format according to one embodiment of the present disclosure.

FIG. 6 is a flowchart illustrating addition details of an exemplary process for creating a firmware update package according to one embodiment of the present disclosure.

FIG. 7 is a flowchart illustrating an exemplary process for performing an over-the-air firmware update according to one embodiment of the present disclosure.

FIG. 8 is a flowchart illustrating additional details of an exemplary process for installing a firmware update package according to one embodiment of the present disclosure.

FIG. 9 is a flowchart illustrating further additional details of an exemplary process for updating partitions of a memory of a target device according to one embodiment of the present disclosure.

FIG. 10 is a flowchart illustrating additional details of an exemplary process for handling a failed over-the-air firmware update according to one embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Various aspects of the present disclosure will be described herein with reference to drawings that may be schematic illustrations of idealized configurations.

Embodiments of the present disclosure are directed to performing an over-the-air firmware update on a device. The firmware update can include re-partitioning of memory of the device and can be performed by using a recovery mode of the device. Generally speaking, a firmware update package including global partitioning tables for partitions to be applied to the memory of the device as well as images, i.e., content, for the partitions can be generated and provided to the device over-the-air. Upon receiving the firmware update package, the device can enter a recovery mode of operation in which the memory of the device can be re-partitioned and the firmware update can be applied.

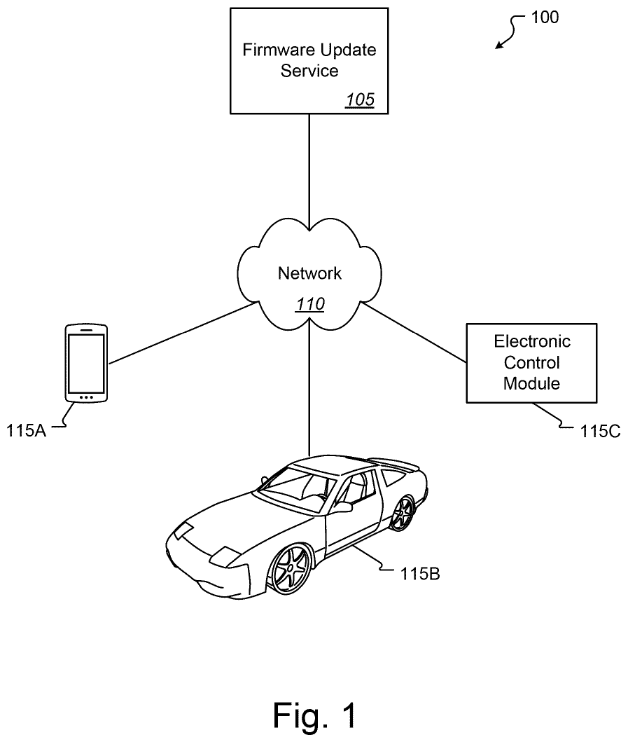

FIG. 1 is a diagram illustrating an exemplary system in which over-the-air firmware updates can be performed according to various embodiments of the present disclosure. As illustrated in this example, the system 100 can include a cloud-based firmware update service 105. The firmware update service 105 can comprise any number of servers and/or other computing devices as known in the art. The firmware update service 105 can be communicatively coupled with a network 110. The network 110 can comprise any one or more local-area and/or wide-area, wired and/or wireless networks as known in the art. According to one embodiment, the network can comprise, at least in part, radio, cellular, and/or other wireless communications channels over which the cloud-based firmware update service 105 can wireless transmit firmware updates to one or more devices 115. These devices 115 can include, but are not limited to, any number of mobile devices 115A such as smart phones, tablets, laptop computers, etc., any number of vehicles 115B including electronic control modules and/or other electronic modules and/or systems, any number of other electronic control modules 115C, e.g., not yet installed in a vehicle 115B and/or installed or yet to be installed in some other type of equipment of machinery, etc.

Generally speaking, and as will be described herein, the firmware update service 105 can generate firmware update packages to be distributed to target devices 115 over-the-air through the network 110. Once a firmware update package is received, the recipient target device 115 can enter a recovery mode to perform an update of the firmware therein. As part of the update, the memory of the recipient target device 115 may also be re-partitioned to accommodate the firmware update. For example, the update may require a different number of partitions on the target device 115, a different size for those partitions, etc. In this way, firmware update can be performed more conveniently and quickly without a need to take or send the target device 115 to a service location, for example. It should be noted that the target device 115 can comprise any one or more devices including, but not limited to a mobile device 115A, an embedded device such as a controller or other component of a vehicle 115B, an electronic control module 115C which may or may not be embedded in another system or device, etc.

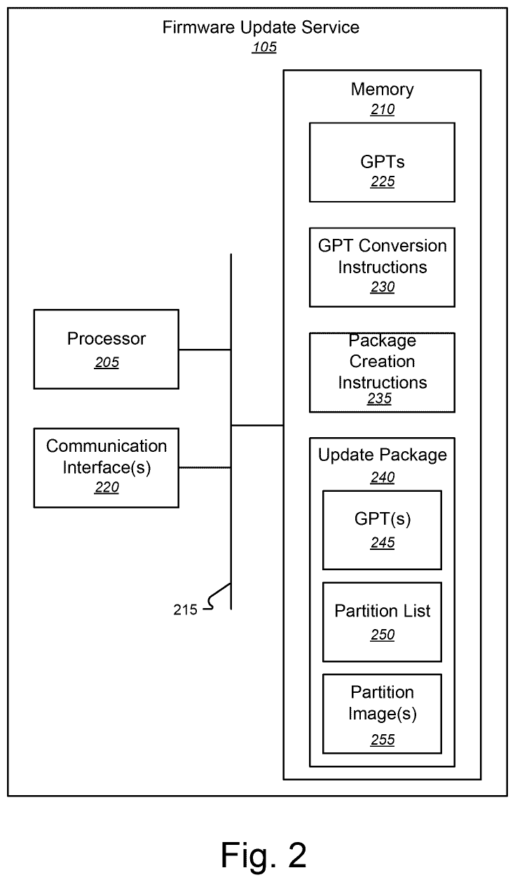

FIG. 2 is a block diagram illustrating additional details of an exemplary firmware update service according to one embodiment of the present disclosure. As illustrated in this example, the firmware update service 105 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the firmware update service 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communications interfaces 220. The communication interfaces 220 can comprise, for example, Ethernet, Bluetooth, WiFi, or other type of wired or wireless communications interfaces.

The memory 210 can store therein a set of global partitioning tables 225 for any number of devices including, but not limited to, mobile devices 115A, electronic control modules and/or other electronic components of vehicles 115B, individual electronic control modules 115C, etc. These global partitioning tables 225 can represent a partitioning to be applied to memory of the target device 115 to be updated.

The memory 210 can also have stored therein a set of global partitioning table conversion instructions 230 and a set of package creation instructions. Generally speaking, the global partitioning table conversion instructions 230, when executed by the processor 205, can cause the processor 205 to convert the stored global partitioning tables 225 to a binary format appropriate for the target device 115 to be updated. The package creation instructions 235, when executed by the processor 205, can cause the processor 205 to create the firmware update package 240 to be provided to the target device 115 over-the-air through the communications interface 220.

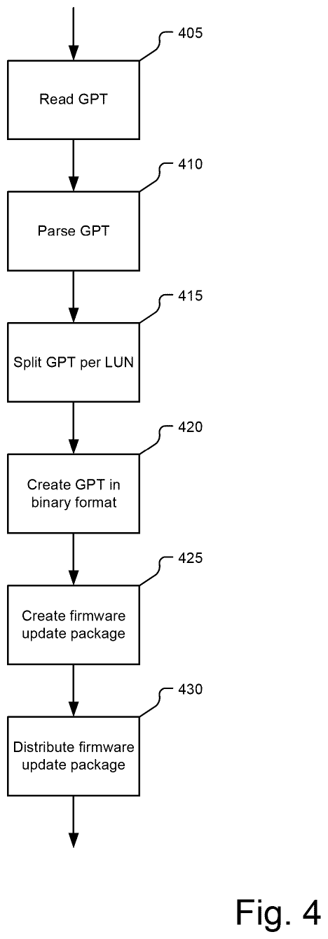

The firmware update package 240, in addition to the binary format global partitioning tables 245 for the memory of the target device 115 being updated can also include a partition list 250 and one or more partition images 255. The partition list can identify the partitions of the memory of the target device 115 being updated while the partition images 255 can comprise the content of those partitions. As used herein, the term “partition image” refers to a complete image of a partition, which can be a binary file that contains all the content of the partition. The term “partition content” refers to the actual data stored in a partition of memory and which can be represented in the partition image. Partition content can be stored, for example, in an XML file format. According to one embodiment, one or more of the partition images 255 can comprise an update to firmware of the target device 115 being updated. Additional details of the processes the global partitioning table conversion instructions 230 and package creation instructions 235 can cause the processor 205 to perform to affect the over-the-air firmware update will be described below with reference to FIGS. 4-6.

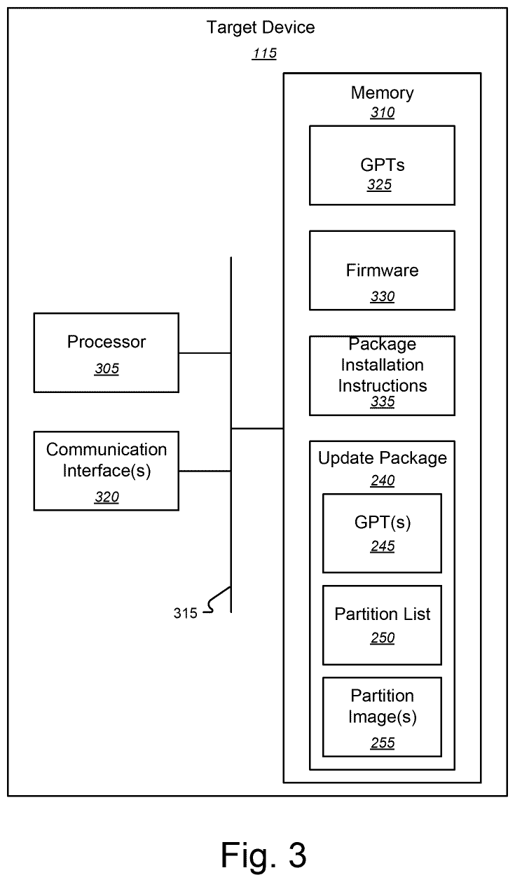

FIG. 3 is a block diagram illustrating additional details of an exemplary mobile device or electronic control module according to one embodiment of the present disclosure. As illustrated in this example, the target device 115 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communications interfaces 320. The communication interfaces 320 can comprise, for example, Ethernet, Bluetooth, WiFi, or other type of wired or wireless communications interfaces.

As known in the art, the memory 310 can be organized by logical unit numbers. A logical unit number (LUN) is a number used for identifying a logical unit relating to computer memory. Also as known in the art, the memory 310 can be partitioned based on the logical unit numbers. The memory 310 can store therein a set of global partitioning tables 325 for the target device 115. These global partitioning tables 325 can include a primary global partitioning table, i.e., a global partitioning table for currently defined partitions of the memory 310, as well as a secondary global partitioning table, i.e., a global partitioning table for previously defined partitions of the memory 310 as will be described further below.

The memory 310 can also have stored therein a set of package installation instructions 335 which, when executed by the processor 305, can cause the processor 305 to receive a firmware update package 240 as described above from the firmware update service 105 over-the-air through the communication interfaces 320 and store the firmware update package 240 in the memory 310 of the target device 115 upon receipt. According to one embodiment, the firmware update package 240 can be stored in a recovery partition of the memory 310. As known in the art, a recovery partition is a dedicated partition on a storage device (such as a hard disk drive or solid-state drive) that contains system recovery tools and data. The purpose of a recovery partition is to provide a way to restore the system to its original state in case of a system failure or other problems. According to embodiments of the present disclosure, this recovery partition can be used to install the firmware update package 240.

Accordingly, and in response to receiving the firmware update package 240, the package installation instructions 335 can further cause the processor 305 to switch from a normal mode of operation for the target device 115 to a recovery mode of operation for the target device 115. Generally speaking, and as known in the art, the normal mode of operation comprises a mode of the operating system of a device in which applications can be executed thereon utilizing the functions of the operating system while recovery mode is a mode of operation in which software applications can be updated and the operating system can be restarted.

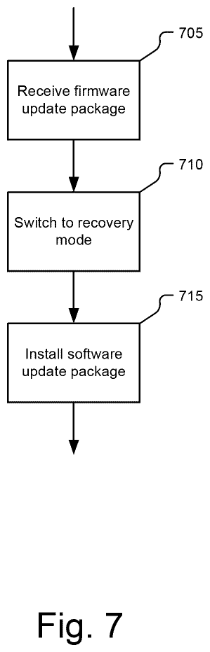

While in the recovery mode of operation for the target device 115, the received firmware update package 240 can be installed to update the firmware 330 of the target device 115. As known in the art, firmware 330 refers to software that has been permanently installed in a machine, device, or microchip, usually by the manufacturer. Such code may be stored in particular portions of the memory 310 such as in a flash memory. Installing the received firmware update package 240 can also update global partition tables of a memory 310 of the target device 115. Additional details of the processes package installation instructions 330 can cause the processor 305 to perform to affect the over-the-air firmware update will be described below with reference to FIGS. 7-10. Once the firmware update package 240 has been installed, the firmware update package 240 may be removed from the memory 310 of the target device 115.

FIG. 4 is a flowchart illustrating an exemplary process for creating and distributing an over-the-air firmware update according to one embodiment of the present disclosure. More specifically, this example illustrates a process as may be performed by a firmware update service 105 as described above to generate the software update package 240. As illustrated in this example, the process can begin with reading 405 a pre-stored global partitioning table 225 for a target device 115 to be updated and parsing 410 the global partitioning table 225. For example, the global partitioning table 225 can be stored in an extensible Markup Language (XML) format file with certain characters or other markers used to identify different portions of file such as portions of the global partitioning table 225 associated with different logical unit numbers within the memory 310 of the target device 115 to be updated. Based on such parsing, the global partitioning table 225 can be split 415 into different portions for the different logical unit numbers within the memory 310 of the target device 115 to be updated.

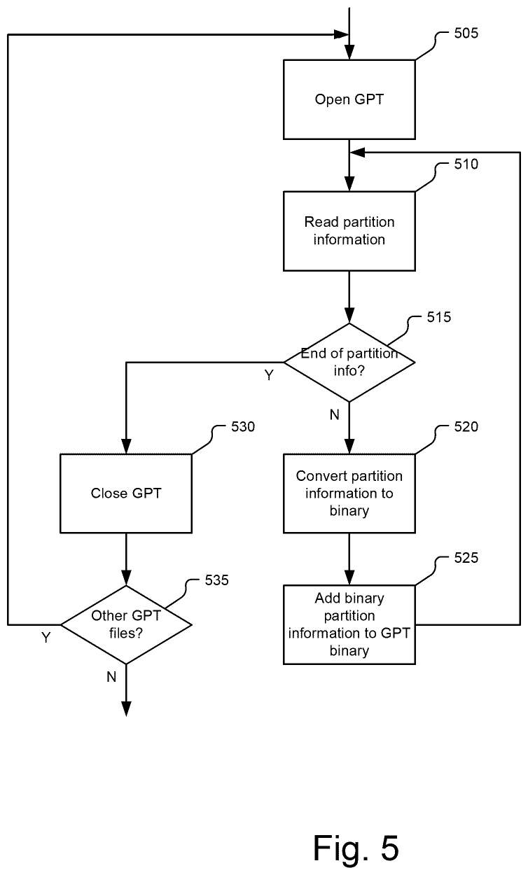

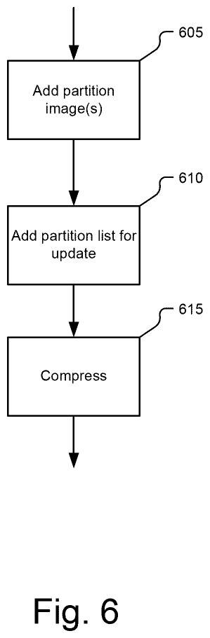

Once the global partitioning table 225 is split 415, a binary format global partitioning table 245 for the firmware update package 240 can be created 420. Additional details of an exemplary process for creating 420 a binary format global partitioning table 245 for the firmware update package 240 will be described below with reference to FIG. 5. Using the binary format global partitioning table 245, the firmware update package 240 can then be created 425 and distributed 430 to one or more target devices 115 wirelessly, over the air. Additional details of an exemplary process for creating 425 the firmware update package 240 will be described below with reference to FIG. 6.

FIG. 5 is a flowchart illustrating additional details of an exemplary process for creating 420 a global partition table in a binary format as introduced in FIG. 4 and according to one embodiment of the present disclosure. As illustrated in this example, creating 420 a global partition table in a binary format can begin with opening 505 the global partitioning table 225 for the target device 115 to be updated and reading 510 the partitioning information therein. A determination 515 can be made as to whether an end of the global partitioning table 225 has yet been reached, i.e., whether partitioning information remains to be processed. In response to determining 515 the end of the global partitioning table 225 has not yet been reached, the partitioning information read 510 from the global partitioning table can be converted 520 to binary format usable by the target device 115 to which the firmware update package 240 will be provided. The converted 520 binary format partitioning information can then be added 525 to the global partitioning table 245 of the firmware update package 240.

The process can continue with reading 510 partitioning information from the global partitioning table 225 for the target device 115 to be updated and determining 515 whether an end of the global partitioning table 225 has yet been reached. In response to determining 515 the end of the global partitioning table 225 has been reached, the global partitioning table 225 can be closed 530 and a determination 535 can be made as to whether addition binary format global partitioning tables remain to be created. In response to determining 535 binary format global partitioning tables remain to be created, the process of creating the binary format global partitioning tables as described above can be repeated until a determination 535 is made that no binary format global partitioning tables remain to be created.

FIG. 6 is a flowchart illustrating addition details of an exemplary process for creating 425 a firmware update package as introduced in FIG. 4 and according to one embodiment of the present disclosure. As illustrated in this example, and in addition to adding 530 the binary format global partitioning tables 245 to the firmware update package 240 as described above, a partition image 255 for each partition of memory 310 of the target device 115 to be updated can be added 605 to the firmware update package 240. A partition list 250 identifying the partitions of the memory 310 of the target device 115 being updated and for which partition images 255 have been added 605 to the firmware update package 240 can also be added 610 to the firmware update package 240. The firmware update package 240 can then be compressed.

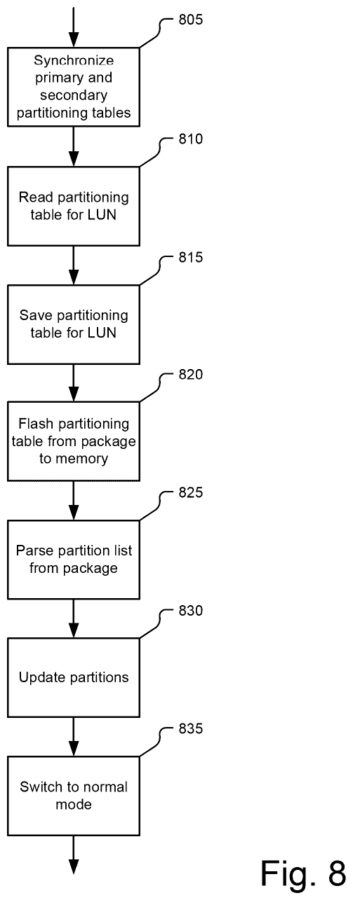

FIG. 7 is a flowchart illustrating an exemplary process for performing an over-the-air firmware update according to one embodiment of the present disclosure. More specifically, this example illustrates a process as may be performed by a target device 115A, electronic control module 115C, or an electronic control module or other electronic component of a vehicle 115B as described above. As illustrated in this example, performing an over-the-air firmware update on a target device 115 can begin with receiving 705, via a wireless communications interface 320, a firmware update package 240 as described above. In response to receiving the firmware update package 240, the target device 115 can be switched 710 from a normal mode of operation to a recovery mode of operation by initiating a reboot process and restarting in the recovery mode. While in the recovery mode of operation, the received firmware update package 240 can be installed 715. Installing 715 the received firmware update package 240 can also update global partition tables of a memory 310 of the target device 115. Additional details of exemplary processes for installing a received firmware update package 240 will be described below with reference to FIGS. 8-10.

FIG. 8 is a flowchart illustrating additional details of an exemplary process for installing 715 a firmware update package as introduced in FIG. 7 and according to one embodiment of the present disclosure. As illustrated in this example, installing the received software package 240 can comprise synchronizing 805 one or more primary global partition tables of the memory 310 of the target device 115 with one or more secondary global partition tables of the memory 310 of the target device 115. That is, the current primary global partition tables for the memory 310 of the target device 115 can be copied to, saved as, or otherwise synchronized with, a secondary or backup set of global partitioning tables. As will be described below, these secondary global partitioning tables can be used to restore the target device 115 in the event of an update failure.

One or more global partitioning tables for one or more logical unit numbers of the memory 310 of the target device 115 can be read 810 from the received firmware update package 240 and one or more global partition tables for the one or more logical unit numbers of the memory 310 of the target device 115 can be saved 815. The global partitioning tables read from the firmware update package 240 can define a re-partitioning of the memory 310 of the target device 115. The one or more global partitioning table for the one or more logical unit numbers of the memory 310 of the target device 115 read from the received firmware update package 240 can then be flashed 820 to the memory 310 of the target device 115.

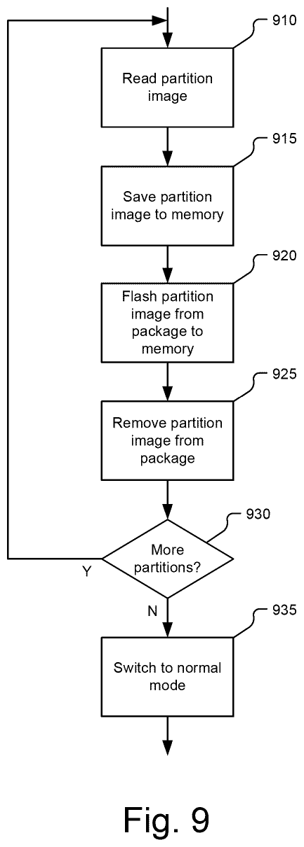

A partition list of the firmware update package 240 can be parsed 825. The partition list can define partitions of the memory 310 of the target device 115 to be updated by the firmware update package 240. Parsing 825 this list can be done based on one or more characters or other markers in the list predefined to indicate separation between items in the list. Partitions of the memory 310 of the target device 115 can then be updated 830 based on the parsed 825 partition list. Additional details of an exemplary process for updating 830 the partitions will be described below with reference to FIG. 9. When the partitions have been updated, operation of the target device 115 can be switched 835 from the recovery mode of operation to the normal mode of operation.

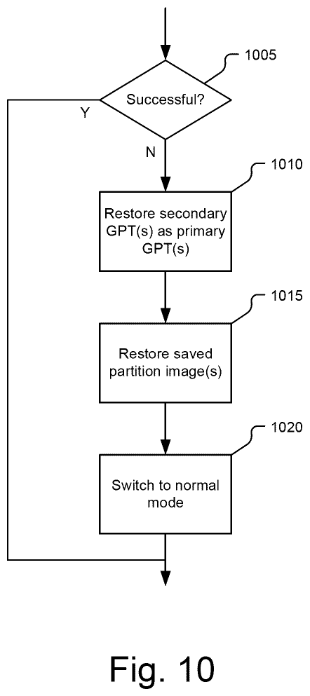

FIG. 9 is a flowchart illustrating further additional details of an exemplary process for updating 830 partitions of a memory of a target device as introduced in FIG. 8 and according to one embodiment of the present disclosure. As illustrated in this example updating partitions of the memory 310 of the target device 115 can begin with reading 910 a partition image from the received firmware update package 240 and saving 915 a partition image corresponding to the update package 240, i.e., the partition of the memory 310 to be updated by the update package 240, from the memory 310 of the mobile target device 115. The saved 915 partition image can be saved, for example, to a secondary recovery partition of the memory and, as will be described below with reference to FIG. 10, these saved 915 partition images can be used to restore the target device 115 in the event of an update failure.

The partition image read 910 from the firmware update package 240 can then be flashed 920 or written to the partition of the memory 310 of the target device 115 being updated and that partition image can be removed 925 from the parsed partition list, i.e., to indicate it's completion. A determination 930 can then be made, based on the parsed partition list, as to whether partitions of the memory 310 of the target device 115 remain to be updated. In response to determining 930 partitions of the memory 310 of the target device 115 remain to be updated, reading 910 a partition image from the received firmware update package 240, saving 915 a corresponding partition image from the memory 310 of the target device 115, flashing 920 or writing the partition image read from the firmware update package 240 to the memory 310 of the target device 115, removing 925 the read partition image from the parsed partition list, and determining 930, based on the parsed partition list, whether partitions of the memory 310 of the target device 115 remain to be updated can be repeated until no partitions of the memory 310 of the target device 115 remain to be update. In response to determining 930 no partitions of the memory 310 of the target device 115 remain to be update, i.e., the parsed partition list is empty, operation of the target device 115 can be switched 935 from the recovery mode of operation to the normal mode of operation.

FIG. 10 is a flowchart illustrating additional details of an exemplary process for handling a failed over-the-air firmware update according to one embodiment of the present disclosure. As illustrated in this example, handling a failed over-the-air firmware update can comprise determining 1005 whether updating the global partition tables of the memory 310 of the target device 115 was successful. This determination 1005 can be made at one or more various points in the processes described above. According to one embodiment, this determination can be made, for example, after flashing 925 a partition image to the memory 310 of the target device 115 as described above with reference to FIG. 9. In response to determining 1005 updating the global partition tables of the memory 310 of the target device 115 was not successful, the one or more secondary global partitioning tables of the memory 310 of the target device 115 can be restored 1010 as the one or more primary global partitioning tables of the memory 310 of the target device 115 and the saved partition images, i.e., saved 915 in a secondary recovery partition as described above with reference to FIG. 9, can be restored 1010 to the memory 310 of the target device 115. Operation of the target device 115 can then be switched 1020 from the recovery mode of operation to the normal mode of operation.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation or technique.

What is claimed is:

1. A method for performing an over-the-air firmware update on a mobile device, the method comprising:
receiving, by a processor of the mobile device, via a wireless communications interface, a firmware update package;
in response to receiving the firmware update package, switching, by the processor of the mobile device, from a normal mode of operation for the mobile device to a recovery mode of operation for the mobile device; and
while in the recovery mode of operation for the mobile device, installing, by the processor of the mobile device, the received firmware update package, wherein installing the received firmware update package updates global partition tables of a memory of the mobile device.

2. The method of claim 1, wherein installing the received firmware update package comprises:
synchronizing one or more primary global partition tables of the memory of the mobile device with one or more secondary partition tables of the memory of the mobile device;
reading one or more global partitioning tables for one or more logical unit numbers of the memory of the mobile device from the received firmware update package;
saving the one or more global partition tables for the one or more logical unit numbers of the memory of the mobile device;
flashing the one or more global partitioning table for the one or more logical unit numbers of the memory of the mobile device read from the received firmware update package to the memory of the mobile device;
parsing a partition list of the firmware update package;
determining, based on the parsed partition list, whether partitions of the memory of the mobile device remain to be updated; and
in response to determining no partitions of the memory of the mobile device remain to be update, switching from the recovery mode of operation of the mobile device to the normal mode of operation of the mobile device.

3. The method of claim 2, further comprising, in response to determining partitions of the memory of the mobile device remain to be updated:
reading a partition image from the received firmware update package;
saving a corresponding partition image from the memory of the mobile device;
flashing the partition image read from the firmware update package to the memory of the mobile device;
removing the read partition image from the parsed partition list;
determining, based on the parsed partition list, whether partitions of the memory of the mobile device remain to be updated; and
in response to determining no partitions of the memory of the mobile device remain to be update, switching from the recovery mode of operation of the mobile device to the normal mode of operation of the mobile device.

4. The method of claim 3, further comprising:
in response to determining partitions of the memory of the mobile device remain to be updated, repeating the reading a partition image from the received firmware update package, saving a corresponding partition image from the memory of the mobile device, flashing the partition image read from the firmware update package to the memory of the mobile device, removing the read partition image from the parsed partition list, and determining, based on the parsed partition list, whether partitions of the memory of the mobile device remain to be updated, until no partitions of the memory of the mobile device remain to be update; and
switching from the recovery mode of operation of the mobile device to the normal mode of operation of the mobile device.

5. The method of claim 3, further comprising determining whether updating the global partition tables of the memory of the mobile device was successful.

6. The method of claim 5, further comprising, in response to determining updating the global partition tables of the memory of the mobile device was not successful:
restoring the one or more secondary global partitioning tables of the memory of the mobile device as the one or more primary global partitioning tables of the memory of the mobile device;
restoring saved partition images to the memory of the mobile device; and
switching from the recovery mode of operation of the mobile device to the normal mode of operation of the mobile device.

7. The method of claim 1, wherein the mobile device comprises a electronic controller module.

8. The method of claim 7, wherein the electronic control module comprises an electronic control module of a vehicle.

9. An electronic control module comprising:
a wireless communications interface;
a processor coupled with the wireless communications interface; and
a memory coupled with and readable by the processor and storing therein a set of instructions which, when executed by the processor, causes the processor to perform an over-the-air firmware update by:
receiving, via the wireless communications interface, a firmware update package;
in response to receiving the firmware update package, switching from a normal mode of operation for the electronic control module to a recovery mode of operation for the electronic control module; and
while in the recovery mode of operation for the electronic control module, installing the received firmware update package, wherein installing the received firmware update package updates global partition tables of the memory of the electronic control module.

10. The electronic control module of claim 9, wherein installing the received firmware update package comprises:
synchronizing one or more primary global partition tables of the memory with one or more secondary partition tables of the memory;
reading one or more global partitioning tables for one or more logical unit numbers of the memory from the received firmware update package;
saving the one or more global partition tables for the one or more logical unit numbers of the memory;
flashing the one or more global partitioning table for the one or more logical unit numbers of the memory read from the received firmware update package to the memory;
parsing a partition list of the firmware update package;
determining, based on the parsed partition list, whether partitions of the memory remain to be updated; and
in response to determining no partitions of the memory remain to be update, switching from the recovery mode of operation to the normal mode of operation.

11. The electronic control module of claim 10, wherein, in response to determining partitions of the memory remain to be updated, the instructions further cause the processor to:
read a partition image from the received firmware update package;
save a corresponding partition image from the memory;
flash the partition image read from the firmware update package to the memory;
remove the read partition image from the parsed partition list;
determine, based on the parsed partition list, whether partitions of the memory remain to be updated; and
in response to determining no partitions of the memory remain to be update, switch from the recovery mode of operation to the normal mode of operation.

12. The electronic control module of claim 11, wherein the instructions further cause the processor to:
in response to determining partitions of the memory remain to be updated, repeating the reading a partition image from the received firmware update package, save a corresponding partition image from the memory, flash the partition image read from the firmware update package to the memory, remove the read partition image from the parsed partition list, and determine, based on the parsed partition list, whether partitions of the memory remain to be updated, until no partitions of the memory remain to be update; and
switch from the recovery mode of operation to the normal mode of operation.

13. The electronic control module of claim 11, wherein the instructions further cause the processor to determine whether updating the global partition tables of the memory was successful.

14. The electronic control module of claim 13, wherein, in response to determining updating the global partition tables of the memory was not successful, the instructions further cause the processor to:
restore the one or more secondary global partitioning tables of the memory as the one or more primary global partitioning tables of the memory;
restore saved partition images to the memory; and
switch from the recovery mode of operation to the normal mode of operation.

15. A vehicle comprising:
a wireless communications interface;
an electronic control module coupled with the wireless communications interface, the electronic control module comprising:
a processor; and
a memory coupled with and readable by the processor and storing therein a set of instructions which, when executed by the processor, causes the processor to perform an over-the-air firmware update on a mobile device by:
receiving, via the wireless communications interface, a firmware update package;
in response to receiving the firmware update package, switching from a normal mode of operation for the electronic control module to a recovery mode of operation for the electronic control module; and
while in the recovery mode of operation for the electronic control module, installing the received firmware update package, wherein installing the received firmware update package updates global partition tables of the memory of the electronic control module.

16. The vehicle of claim 15, wherein installing the received firmware update package comprises:
synchronizing one or more primary global partition tables of the memory of the mobile device with one or more secondary partition tables of the memory;
reading one or more global partitioning tables for one or more logical unit numbers of the memory from the received firmware update package;
saving the one or more global partition tables for the one or more logical unit numbers of the memory;
flashing the one or more global partitioning table for the one or more logical unit numbers of the memory read from the received firmware update package to the memory;
parsing a partition list of the firmware update package;
determining, based on the parsed partition list, whether partitions of the memory remain to be updated; and
in response to determining no partitions of the memory remain to be update, switching from the recovery mode of operation to the normal mode of operation.

17. The vehicle of claim 16, wherein, in response to determining partitions of the memory remain to be updated, the instructions further cause the processor to:
read a partition image from the received firmware update package;
save a corresponding partition image from the memory;
flash the partition image read from the firmware update package to the memory;
remove the read partition image from the parsed partition list;
determine, based on the parsed partition list, whether partitions of the memory remain to be updated; and
in response to determining no partitions of the memory remain to be update, switch from the recovery mode of operation to the normal mode of operation.

18. The vehicle of claim 17, wherein the instructions further cause the processor to:
in response to determining partitions of the memory remain to be updated, repeating the reading a partition image from the received firmware update package, save a corresponding partition image from the memory, flash the partition image read from the firmware update package to the memory, remove the read partition image from the parsed partition list, and determine, based on the parsed partition list, whether partitions of the memory remain to be updated, until no partitions of the memory remain to be update; and
switch from the recovery mode of operation to the normal mode of operation.

19. The vehicle of claim 17, wherein the instructions further cause the processor to determine whether updating the global partition tables of the memory was successful.

20. The vehicle of claim 19, wherein, in response to determining updating the global partition tables of the memory was not successful, the instructions further cause the processor to:
restore the one or more secondary global partitioning tables of the memory as the one or more primary global partitioning tables of the memory;
restore saved partition images to the memory; and
switch from the recovery mode of operation to the normal mode of operation.
